(19) United States
(12) Patent Application Publication
(10) Pub. No.: US 2025/0111553 A1
(43) Pub. Date: Apr. 3, 2025

(54) METHODS AND SYSTEMS IN TEXT-TO-IMAGE DIFFUSION MODELS FOR FAIRNESS

(71) Applicant: Garena Online Private Limited, Singapore (SG)

(72) Inventors: Xudong SHEN, Singapore (SG); Chao DU, Singapore (SG); Tianyu PANG, Singapore (SG); Min LIN, Singapore (SG)

(21) Appl. No.: 18/898,603

(22) Filed: Sep. 26, 2024

(30) Foreign Application Priority Data
Sep. 28, 2023 (SG) 10202302772X
Sep. 26, 2024 (SG) 10202402993P

(51) Int. Cl. G06T 11/00; G06F 18/241; G06F 40/40; G06N 3/084

(52) U.S. Cl. CPC G06T 11/00; G06F 18/241; G06N 3/084; G06F 40/40

(57) ABSTRACT

The present invention provides solutions for reducing biases in text-to-image diffusion models, particularly biases related to gender, race, and their intersections in occupational prompts. The invention introduces a fairness framework based on distributional alignment, comprising two core technical solutions: (1) a distributional alignment loss that adjusts the output of the model toward user-defined target distributions, and (2) an adjusted direct finetuning (adjusted DFT) of the model's sampling process using an adjusted gradient to optimize losses based on generated images. These techniques reduce bias while supporting diverse perspectives on fairness, such as age-controlled debiasing across multiple concepts. The method's scalability allows for debiasing multiple prompts simultaneously, improving the inclusivity of diffusion model outputs across varied demographics.

### CROSS REFERENCE TO RELATED APPLICATIONS

This patent application claims the benefit and priority of Singaporean Provisional Patent application Ser. No. 10/202,302772X, filed with the Intellectual property Office of Singapore on Sep. 28, 2023 entitled “FAIRNESS GUIDANCE ON TEXT-TO-IMAGE DIFFUSION MODELS,” and of Singaporean patent application number 10202402993P, filed with the Intellectual property Office of Singapore on Sep. 26, 2024, entitled “METHODS AND SYSTEMS IN TEXT-TO-IMAGE DIFFUSION MODELS FOR FAIRNESS,” the contents of which are incorporated by reference in their entireties.

### TECHNICAL FIELD

The present invention generally relates to a method and system for text-to-image generation and, more particularly relates to a method and system for bias mitigation in text-to-image diffusion models through distributional alignment loss and adjusted direct finetuning.

### BACKGROUND

Text-to-image (T2I) diffusion models have witnessed an accelerated adoption by corporations and individuals alike. The scale of images generated by these models is staggering.

However, this influx of content from diffusion models into society underscores an urgent need to address their biases. The rapid adoption of T2I diffusion models has brought about challenges related to biases, such as racial, gender, and occupational bias. Hence, these models often fail to represent minority groups fairly. To address potential issues of fairness for the generated images, there is a clear need to improve the method of image generation within the diffusion model.

Furthermore, other desirable features and characteristics will become apparent from the subsequent detailed description and the appended claims, taken in conjunction with the accompanying drawings and this background of the disclosure.

### SUMMARY OF THE INVENTION

In accordance with one aspect of the present invention, there is provided a method of generating images from a text to reduce bias using a diffusion model, comprising: receiving a text input; and generating images corresponding to the text input using the diffusion model; wherein the diffusion model is optimized by: aligning the generated images toward a target distribution using a distributional alignment loss; adjusting the diffusion model by direct finetuning a sampling process by adjusting a gradient to minimize a loss function of the generated images.

In some embodiments, the step of aligning the generated images further comprises identifying attributes in the generated images using pre-trained classifiers; aligning the identified attributes of the generated images toward a target attribute distribution using the distributional alignment loss.

In some embodiments, the step of aligning the generated images further comprises applying pre-trained classifiers to estimate class probabilities of the generated images, including probabilities for specific classes; calculating a transport distance between the estimated class probabilities of the generated images and the target distribution; dynamically generating the class distributions of the generated images that match the target distribution by minimizing the transport distance.

In some embodiments, the distributional alignment loss is applied iteratively until generated image features align with the target distribution.

In some embodiments, the distributional alignment loss further comprises an alignment loss that measures a discrepancy between the generated image and a target distribution, an image semantics preserving loss that measures a semantic consistency of the generated image with the input text, or a face realism preserving loss that penalizes the dissimilarity between the generated face and a closest face from a set of external real faces.

In some embodiments, the distributional alignment loss is a weighted sum of the alignment loss, the image semantics preserving loss, and/or the face realism preserving loss.

In some embodiments, the target distribution is a user defined target distribution and includes one or more attributes.

In some embodiments, the target distribution is a non-uniform distribution.

In some embodiments, the non-uniform distribution is over age, gender, race or their intersection.

In some embodiments, the step of direct finetuning a sampling process further comprises preparing gradient coefficients of the diffusion model; calculating a gradient value from the gradient coefficients; adjusting the gradient value to optimize the diffusion model by minimizing the loss function; backpropagating the adjusted gradient value through the diffusion model to update model parameters.

In some embodiments, the gradient value is calculated based on partial derivatives of the loss function with respect to the model parameters.

In some embodiments, the method further comprises debiasing multiple concepts at once by including different inputs in a finetuning data.

In some embodiments, the text input is processed using a natural language processing model to understanding semantic features before being used by the diffusion model for image generation.

In some embodiments, the finetuning process adjusts the diffusion model's parameters using five soft tokens.

In some embodiments, the diffusion model is a text to image model.

In accordance with another aspect of the present invention, there is provided a system of generating images from a text to reduce bias using a diffusion model comprising: a processor; a memory in electronic communication with the processor; and instructions stored in the memory and executable by the processor to cause the system to: receiving a text input; and generating images corresponding to the text input using the diffusion model; wherein the diffusion model is optimized by: aligning the generated images toward a target distribution using a distributional alignment loss; adjusting the diffusion model by direct finetuning a sampling process by adjusting a gradient to minimize a loss function of the generated images.

In some embodiments, the system further comprises applying pre-trained classifiers to estimate class probabilities of the generated images, including probabilities for specific classes; calculating a transport distance between the estimated class probabilities of the generated images and the target distribution; dynamically generating the class distributions of the generated images that match the target distribution by minimizing the transport distance.

In some embodiments, the distributional alignment loss further comprises an alignment loss that measures a discrepancy between the generated image and a target distribution, an image semantics preserving loss that measures a semantic consistency of the generated image with the input text, or a face realism preserving loss that penalizes the dissimilarity between the generated face and a closest face from a set of external real faces.

In accordance with another aspect of the present invention, there is provided an apparatus of generating images from a text to reduce bias using a diffusion model comprising: means for receiving a text input; means for generating images corresponding to the text input using the diffusion model; means for computing a gradient matrix for each image in the set of training images; wherein the diffusion model is optimized by aligning the generated images toward a target distribution using a distributional alignment loss; adjusting the diffusion model by direct finetuning a sampling process by adjusting a gradient to minimize a loss on the generated images.

In accordance with another aspect of the present invention, there is provided a computer-readable storage medium, on which a computer program is stored, wherein the computer program, when executed in a computer, causes the computer to perform the method of any one of the methods discussed hereinabove.

It should be understood that the embodiments described herein are not exhaustive and that additional features and variations of the invention may be incorporated. Various other advantages and novel features of the invention will become apparent from the following detailed description when considered in conjunction with the accompanying drawings.

### BRIEF DESCRIPTION OF THE DRAWINGS

The disclosure will be better understood with reference to the detailed description when considered in conjunction with the non-limiting examples and the accompanying drawings, in which:

FIG. 1 is an architecture diagram of a text-to-image generation system according to an embodiment of the invention.

FIG. 2 is a flowchart of a text-to-image generation system according to an embodiment of the invention.

FIG. 3 is a block diagram of an electronic device for the text-to-image generation according to an embodiment of the invention.

FIG. 4 is a flowchart of a method of generating unbiased images by a text-to-image generation system according to an embodiment of the invention.

FIG. 5 is a flowchart of a method of adjusted direct finetuning for text-to-image generation according to an embodiment of the invention.

FIG. 6a is a chart of the training loss during direct finetuning with three distinct gradients according to an embodiment of the invention.

FIG. 6b is a chart of the scales of the gradients at different time steps according to an embodiment of the invention.

FIG. 7 shows the comparison of unadjusted and adjusted direct finetuning of the diffusion model of the sampling process according to an embodiment of the invention.

FIG. 8 shows the images generated from the original stable diffusion model (8a) and the jointly debiased stable diffusion model (8b) for gender and race, according to an embodiment of the invention.

FIG. 9 is a chart of the frequency of age=old representations in generated images across various occupations for both the debiased diffusion model and the original stable diffusion according to an embodiment of the invention.

### DETAILED DESCRIPTION

In the following detailed description, reference is made to the accompanying drawings, which form a part hereof. The illustrative embodiments described in the detailed description, drawings and claims are not meant to be limiting. Other embodiments can be utilized, and other changes can be made, without departing from the spirit or scope of the subject matter presented herein. Unless specified otherwise, the terms “comprising”, “comprise”, “including” and “include” used herein, and grammatical variants thereof, are intended to represent “open” or “inclusive” language such that they include recited elements but also permit inclusion of additional, un-recited elements.

The various embodiments are not necessarily mutually exclusive, as some embodiments can be combined with one or more other embodiments to form new embodiments. Embodiments described in the context of one of the systems or methods are analogously valid for the other systems or methods. Similarly, embodiments described in the context of a method are analogously valid for a system, an apparatus or a computer program, and vice-versa.

Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

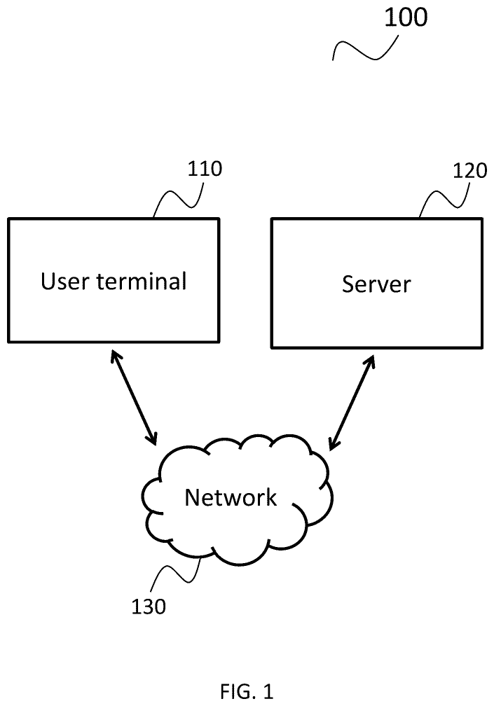

FIG. 1 is an architecture diagram of a text-to-image generation system according to an embodiment of the invention.

The system 100 comprises a user terminal 110, a server 120 and a communication network 130, designed to generate images based on input text provided by the user. In some embodiments, the text-to-image generating system 100 may include a plurality of user terminals 110 and a plurality of servers 120.

The user terminal 110 may be a browser, application (APP), or a web application, or a light application (also called applet, a lightweight application) or cloud application, etc. The user terminal 110 may be deployed in an electronic device, need to run depending on the device or some APP in the device, etc. The electronic device may have a display screen and support information browsing, etc., for example, may be a terminal-side device such as a personal mobile terminal, e.g., a mobile phone, a tablet computer, a personal computer, etc.

The user terminal 110 provides a user interface where the user can input text. This text is the basis for the image generation process. Once the user submits the text, the user terminal 110 transmits the input to the server 120 over a network 130.

The server 120 receives the text data from the user terminal 110 and processes it to generate an image corresponding to the user's input. The server 120 utilizes a text-to-image generation model, which is based on a pre-trained diffusion or generative model. This model converts the textual input into visual features and constructs an image. The server may process the text to extract semantic meanings, context, and any specific attributes mentioned in the text to guide the image generation process. Once the image is generated, the server 120 transmits the image back to the user terminal 110.

The server 120 may be responsible for providing a wide range of services, such as facilitating communication between multiple users, supporting background training for models deployed on user terminal devices, and processing data received from users. It is important to note that the server 120 can be implemented in various configurations. It may function as a distributed server cluster comprising multiple servers or operate as a single server. The server may also be a server of a distributed system. Moreover, the server 120 can also be a cloud-based server (cloud-side device), providing essential cloud computing services. These services may include cloud storage, cloud databases, cloud functions, cloud networking, cloud communication, middleware services, domain name services, security services, content delivery networks (CDNs), big data processing, artificial intelligence (AI) platforms, or intelligent cloud computing powered by AI technologies. The server's architecture can be scaled based on system requirements, ensuring flexibility and robust performance.

The communication between the user terminal 110 and the server 120 is established over a network 130, which can include the internet, cellular networks, or other wireless communication technologies. Data sent by the user terminal 110 may be encoded, compressed, or encrypted before transmission to ensure security and efficiency. The server 120, upon generating the image, sends it back to the user terminal 110 using the same network connection 130.

After receiving the generated image from the server 120, the user terminal 110 decodes and renders the image on the device. The user can then view, download, or share the image through the terminal's interface.

This system 100 facilitates a seamless text-to-image generation workflow, where user input is converted into a visual representation using advanced AI models hosted on the server 120. The entire process is automated and designed for real-time interaction between the user terminal 110 and the server 120.

It should be noted that, the text image generating system provided in the embodiments of the present disclosure is generally executed by the server, but in other embodiments of the present disclosure, the user terminal device may also have a similar function to the server, so as to execute the text-to-image generating method provided in the embodiments of the present disclosure. In other embodiments, the text-to-image generating method provided in the embodiments of the present disclosure may be performed by a user terminal and a server together.

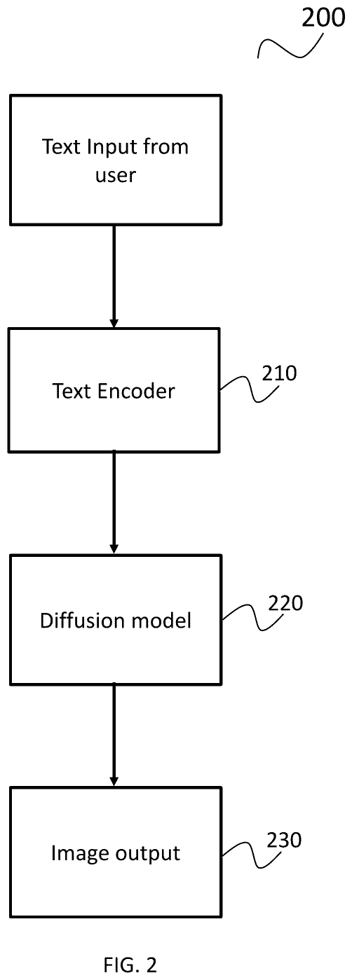

FIG. 2 is a flowchart of a text-to-image generation method according to an embodiment of the invention. This method effectively balances creative image generation with fairness considerations, ensuring inclusivity and representation across various dimensions such as race, gender, and other demographic characteristics.

The method 200 begins with receiving an input text from a user. The input is first processed by a text encoder 210, which parses and understands the textual input, extracting key semantic and contextual features. This understanding helps in identifying the specific characteristics the user wants in the generated image, such as objects, settings, or specific traits like gender or race.

In some embodiments, the method includes processing input text using Natural Language Processing (NLP) techniques to generate corresponding images in the text-to-image generation system. The method enables the system to understand the semantic meaning of the text input and convert it into a visual representation through a model-driven process.

The method begins by receiving a text input from a user terminal. The method applies NLP techniques to process the input, extracting meaningful features such as key entities, actions, and descriptive attributes. This includes breaking down the text into relevant components to understand its structure, context, and semantic roles.

After processing the text, the method encodes the semantic meaning into a format suitable for input into the text-to-image generation model. The encoded text is then used by the generation model to create an image that aligns with the characteristics and context provided by the input text.

Next, the processed text is input into a finetuned diffusion model 220, which is specifically trained to address and mitigate biases. The model employs a bias-reduction mechanism, such as distributional alignment or adjusted finetuning, to ensure that the generated images are not biased. The diffusion model has been trained on a wide range of diverse data, ensuring that it generates fair and balanced representations across gender, race, and/or other factors.

The final image output 230 is a bias-reduced, fair image generated from the input text. The method generates the image based on the user's input while ensuring that the representation aligns with fairness principles, thereby producing outputs free from biased depictions or disproportionate emphasis on certain groups.

In some embodiments, the generated images are facial images, which may include a singular face captured from various angles or with varying expressions. In some embodiments, the generated images may consist of multiple faces within a single image, allowing for the identification or representation of several individuals simultaneously.

The resulting image is generated based on the input text and is transmitted back to the user terminal. This process allows for an efficient and context-aware generation of images from text, providing users with visually accurate and unbiased outputs.

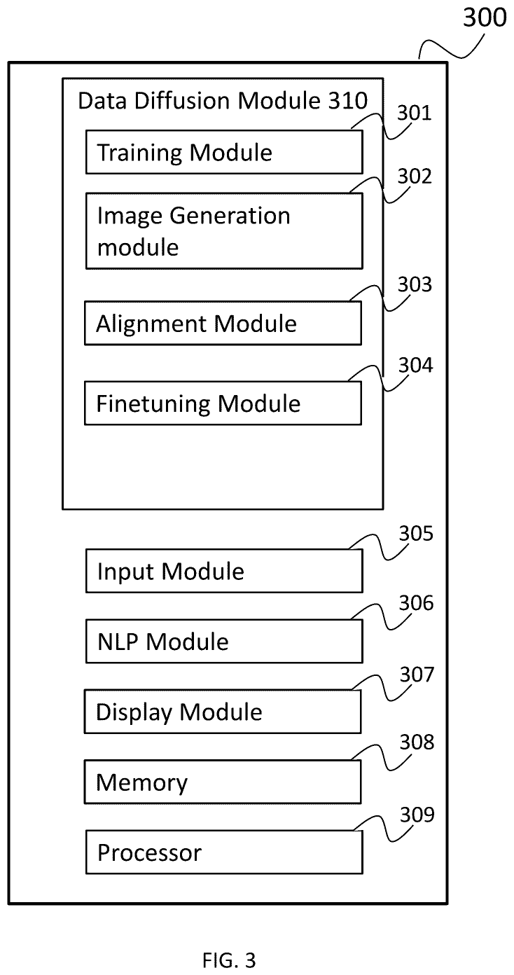

FIG. 3 is a block diagram of an electronic device for the text-to-image generation according to an embodiment of the invention. The electronic device 300 may include a data diffusion module 310, an input module 305, an NLP module 306, a display module 307, one or more memories 308 and one or more processors 309.

The data diffusion module 310 further comprises a data training module 301, an image generation module 302, an alignment module 303 and a finetuning module 304. The diffusion model 310 takes the input training images and processes them through a series of diffusion steps to generate the final output image.

The data training module 301 is responsible for collecting and preprocessing the input training images. These images serve as the foundational data used by the diffusion model 310. The input training images are prepared and collected to the diffusion model 310 for processing.

In some embodiments, in the preprocessing step for image generation, the input images are prepared to ensure consistency and quality, which is vital for the effectiveness of the diffusion model. This process typically involves normalizing the images to a uniform scale, resizing them to match the model's input requirements, and applying data augmentation techniques such as flipping, rotating, or color adjustments to enhance the model's ability to generalize from the data. This thorough preprocessing ensures that the diffusion model starts with well-prepared data, leading to better and more reliable output images.

The image generation module 302 is the module that generates images using the diffusion model, either the original or the retrained one. This is the core model responsible for generating the output images from the input training images of the diffusion model. The diffusion model might be a Latent Diffusion Model (LDM) or any other similar model designed to generate images.

The alignment module 303 is to adjust specific attributes in the generated images toward a target distribution defined by the user. This distributional alignment loss adjusts the characteristics of the generated images by steering them toward a user-defined target distribution, ensuring that the model produces images that align with fairness standards. This allows for flexible definitions of fairness, such as age, gender, and race distributions, depending on the user's goals.

The finetuning module 304 is for the direct finetuning of the diffusion model's sampling process, with an adjustment applied to the gradient that optimizes the loss on the generated images. It leverages an adjusted gradient to directly optimize losses that are defined on the generated images during the sampling process of the diffusion model. By adjusting the gradient during finetuning, the model can reduce biases at the output level while maintaining high image quality. This method is particularly effective when finetuning with a limited number of tokens, making it resource efficient.

Input module 305 is responsible for capturing user input in the form of text. It serves as the interface where users can provide queries, commands, or any other textual data. This module ensures that the input is properly formatted and prepared for further processing. It handles various types of text inputs, ranging from natural language sentences to structured commands, and forwards them to the NLP module for further analysis.

NLP module 306 processes the user input text received from the input module 305. It applies advanced NLP techniques to understand the meaning and intent behind the user's text. This module extracts key entities, identifies the user's intent, and performs any necessary semantic analysis to comprehend the context of the input.

In some embodiments, the key functionalities of the NLP module 306 include: tokenizing and parsing the text input; identifying and classifying key entities such as dates, names, or locations; determining the intent behind the user's input; leveraging machine learning models to interpret and contextualize the input for the next stage of processing.

Display module 307 displays the final output images generated by the diffusion module 310.

In some embodiments, the system includes a memory 308. It stores the training images along with their importance scores for further analysis or future use. The memory 308 may include one or more non-transitory computer-readable storage media that may be non-transitory. The memory 308 may further include a high-speed random access memory and a non-volatile memory, such as one or more magnetic disk storage devices or flash storage devices. In some embodiments, a non-transitory computer-readable storage medium in the memory 308 is configured to store at least one piece of program code, the at least one piece of program code being configured to be executed by the processor 309 to implement the data diffusion and data attribution provided in the method embodiments of the invention.

In some embodiments, the user equipment includes a processor 309. The processor 309 can be implemented using various technologies and architectures designed to fulfil the described functions. It may be realized as a general-purpose processor, content addressable memory, digital signal processor, application-specific integrated circuit, field-programmable gate array, programmable logic device, discrete gate or transistor logic, discrete hardware components, or a combination thereof. Additionally, a processor can take the form of a microprocessor, controller, microcontroller, or state machine.

Furthermore, the processor 309 may be realized through a combination of computing devices, such as combining a digital signal processor with a microprocessor, utilizing multiple microprocessors, integrating one or more microprocessors with a digital signal processor core, or employing any other suitable configuration.

A person skilled in the art will recognize that the structure depicted in FIG. 3 is not limited to the electronic device 300. The electronic device 300 may include additional or fewer components than those illustrated, some components may be combined, or alternative component configurations may be employed.

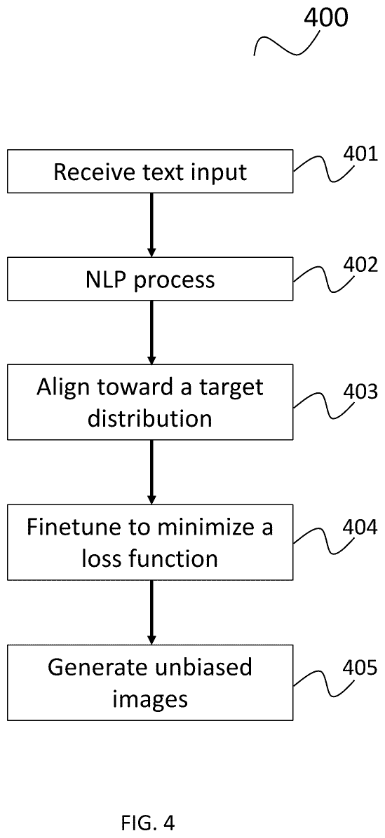

FIG. 4 is a flowchart of a method of generating unbiased images by a text-to-image generation system according to an embodiment of the invention. As a preliminary matter, it should be understood that steps of the method 400 are not necessarily limiting, and that steps can be added, omitted, and/or performed simultaneously without departing from the scope of the appended claims. It should be appreciated that the method 400 may include any number of additional or alternative tasks, and that the method 400 may be incorporated into a more comprehensive procedure or process having additional functionality not described in detail herein. Moreover, one or more of the tasks shown in FIG. 4 could be omitted from an embodiment of the method 400 as long as the intended overall functionality remains intact. It should also be understood that the illustrated method 400 can be stopped at any time. The method 400 is computer-implemented in that various tasks or steps that are performed in connection with the method 400 may be performed by software, hardware, firmware, or any combination thereof.

This flowchart describes an efficient process for producing text-generated images while addressing and minimizing biases, providing an enhanced solution for fair image generation. The process includes the following steps:

At step 401, it receives the text input. The method receives a user-provided text input through a user terminal device. This text serves as the basis for generating an image. For example, the text input can be “a photo of the face of an electrical and electronics repairer”.

At step 402, it processes and understands the user text input using NLP algorithms. The received text is processed using NLP techniques to comprehend the semantic meaning and context. The system analyzes the text to extract key information such as objects, descriptions, or any specific characteristics mentioned by the user.

At step 403, it aligns the distribution of the generated images towards the target distribution. The system utilizes a distributional alignment loss mechanism, which adjusts the characteristics of the generated image to align with a user-defined target distribution. This ensures that specific traits such as race, gender, and other attributes are represented fairly, according to the defined target distribution.

In some embodiments, the user defines a target distribution for one or more attributes, such as gender or race. The diffusion model generates an initial batch of images based on the user input prompts. The generated images are compared to the target distribution, and a loss is calculated based on the deviation from the target. The model is then adjusted iteratively to minimize the distributional alignment loss, steering the characteristics of the images toward the user-defined target. This loss function dynamically steers image generation towards a user-defined distribution of attributes like gender, race, or age while maintaining the integrity and semantics of the generated images.

In some embodiments, the step of aligning the generated images involves the following process: pre-trained classifiers are used to detect and identify specific attributes in the generated images, such as age, gender, race, or other relevant features. The identified attributes are then aligned toward a predefined target attribute distribution. This alignment is achieved by applying the distributional alignment loss, which adjusts the generated images to ensure that their attributes match the target distribution. The process helps in reducing biases and improving the fairness of the image generation. This step ensures that the generated images not only reflect the input prompts but also align with a desired balance of attributes, contributing to fair and representative outputs.

In some embodiments, the step of aligning the generated images involves applying pre-trained classifiers to the generated images. These classifiers estimate the class probabilities of the generated images, determining the likelihood of each image belonging to specific classes such as gender, race, or age groups. A transport distance is computed between the estimated class probabilities of the generated images and a predefined target distribution. This metric measures the difference between the actual distribution of generated images and the desired balanced distribution. The class distributions of the generated images are dynamically adjusted to match the target distribution. This is achieved by minimizing the transport distance, ensuring that the generated images better align with the target attribute balance. This process refines the alignment of generated images, ensuring that the class distribution of the output is consistent with the desired distribution, reducing bias and improving fairness.

In some embodiments, the target distribution is a user-defined distribution that specifies the desired balance of attributes in the generated images. This distribution can include multiple attributes simultaneously, such as gender, race, age, and other relevant characteristics. By defining this target distribution, users can guide the image generation process to ensure that the outputs align with specific demographic or attribute-based goals, allowing for more customized and balanced representations across various dimensions. A target distribution for each attribute is specified. For example, the user may define a uniform distribution that 50% of the generated images should represent women and 50% men, or that 75% should be young and 25% old.

In some embodiments, the process iteratively adjusts the model until the generated images align closely with the target demographic distribution. The distributional alignment loss is applied iteratively during the image generation process. With each iteration, the generated image features are progressively adjusted to reduce the discrepancy between the current distribution and the target distribution. This iterative application continues until the features of the generated images align with the predefined target distribution, ensuring that the final outputs reflect the desired balance of attributes.

In some embodiments, to ensure that the generated images remain high-quality, additional loss functions are introduced, which are the alignment loss, image semantics preserving loss and face realism preserving loss. For the alignment loss, it measures the discrepancy between the generated image and a target distribution. It ensures that the output image aligns with a predefined distribution, such as a balanced representation of age, gender, or race. For the image semantics preserving loss, it measures the semantic consistency between the generated image and the input text prompt. It ensures that the image accurately reflects the meaning and attributes described in the text, preserving the intent of the prompt. For the face realism preserving loss, it penalizes dissimilarities between the generated face and the closest match from a set of real external faces. It ensures that the generated face maintains realistic human features by comparing it to real-world face data. The final distributional alignment loss the distributional alignment loss comprises one of the three components and is calculated as a weighted sum of these components, ensuring that the generated image is both semantically accurate and visually realistic while adhering to the target distribution.

At step 404, it applies the adjusted Direct Finetuning (DFT) of the diffusion model to minimize a loss function. The diffusion model undergoes an adjusted DFT process by an adjusted gradient-based optimization of the model's sampling process. This involves leveraging an adjusted gradient to directly optimize the loss functions associated with the generated images. This step allows the model to further improve image quality and ensure that the generation process adheres to fairness principles.

The adjusted DFT approach includes calculating an adjusted gradient that directly optimizes for bias reduction (e.g., based on gender or racial bias) in the generated images. Finetuning the diffusion model with this adjusted gradient, which allows for efficient bias reduction without requiring extensive computational resources. Notably, this method achieves substantial reductions in gender bias with as few as five soft tokens during finetuning.

At step 405, it generates unbiased images. The method significantly reduces gender and racial biases, as well as intersectional biases, particularly in cases where occupational prompts are used. By ensuring balanced and fair representations in the output, the generated images reflect diversity and inclusivity across various attributes.

In some embodiments, the method is designed to handle multiple bias factors simultaneously. For example, when debiasing images related to occupational prompts, the method can simultaneously ensure balanced gender representation and account for diverse racial groups. Additionally, the method supports fairness considerations beyond strict equality, allowing for distributions that reflect specific demographic compositions. The system's scalability ensures that users can debias several prompts in parallel, providing flexibility and efficiency in bias mitigation. The method is capable of reducing multiple biases simultaneously, such as those related to gender, race, and age, by incorporating corresponding prompts into the finetuning data. For instance, the method can control the distribution of generated images to reflect both young and old individuals while simultaneously debiasing gender and racial attributes. The scalability of the method ensures that multiple concepts can be debiased in parallel.

The method provides a robust, scalable solution for mitigating bias in text-to-image diffusion models. By introducing distributional alignment loss and adjusted direct finetuning, the invention reduces biases while maintaining model flexibility, ensuring fairer and more representative outputs. It can balance multiple attributes at once (e.g., age, gender, and race) by including relevant prompts in the finetuning data. The method is scalable, allowing multiple concepts to be debiased simultaneously by incorporating them into the finetuning dataset. This flexibility ensures the system can handle complex demographic distributions while maintaining image quality.

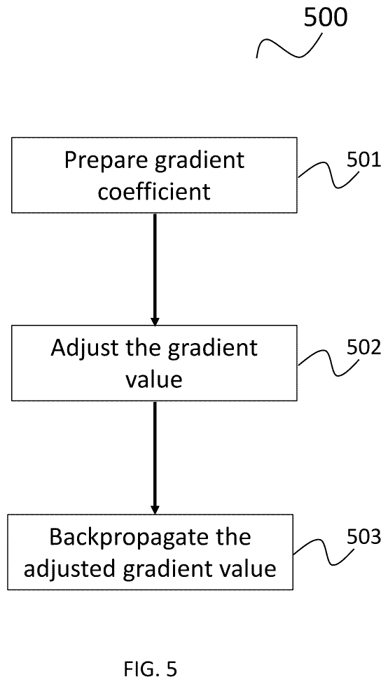

FIG. 5 is a flowchart of a method of adjusted direct finetuning for text-to-image generation according to an embodiment of the invention.

At step 501, it prepares the gradient coefficient. In this step, a gradient coefficient is prepared. This coefficient serves as a key factor in adjusting the model's gradient, ensuring that the model is guided to reduce specific types of biases during the optimization process.

At step 502, it adjusts the gradient. The method first calculates the gradient based on the current output of the diffusion model. This involves computing the gradient value based on partial derivatives of the loss function with respect to the model parameters.

Once the gradient is calculated, it is adjusted using the prepared gradient coefficient. This adjustment helps fine-tune the optimization process, enabling the model to focus on reducing particular losses, such as those related to biases in gender, race, or other attributes. The adjusted gradient ensures that the model produces fairer outputs while improving the overall quality of the generated images.

In some embodiments, the adjusted gradient-based method is applied to optimize the model's sampling process directly. The method removes the dependence on earlier or later timesteps by focusing only on the current step's gradient. This allows for direct optimization, reducing the coupling between different stages of the image generation process and simplifying finetuning.

At step 503, in this final step, the adjusted gradient is backpropagated through the diffusion model. After computing the gradient from the generated image, the system backpropagates through the model, adjusting not just the final layers responsible for image creation, but also the earlier layers linked to interpreting the text prompt. This way, the entire model, from text input to final image output, is refined to produce fairer images.

In some embodiments, the method supports scalable fairness optimization, allowing the model to debias multiple concepts at once. For instance, the system can simultaneously reduce gender and racial bias in images by incorporating these concepts in the finetuning data.

In some embodiments, it allows users to define diverse fairness parameters, such as maintaining a 75% young and 25% old demographic distribution while also ensuring gender balance in the generated content.

In some embodiments, the finetuning process is scalable and can achieve bias reduction with minimal adjustments to the model's parameters. For example, bias can be reduced with the introduction of just five soft tokens, allowing fine-grained control of the generated image characteristics.

### EXAMPLE

### Background on Diffusion Models

Diffusion models assume a forward diffusion process that gradually injects Gaussian noise to a data distribution q(x₀) according to a variance schedule β₁, . . . , β_{T}::

$$q ( {x}_{1 : T} \vert {x}_{0} ) = {\prod }_{t = 1}^{T} q ( {x}_{t} \vert {x}_{t - 1} ) , q ( {x}_{t} \vert {x}_{t - 1} ) = 𝒩 ( {x}_{t} \vert \sqrt{1 - {β}_{t}} {x}_{t - 1} , {β}_{t} I ) , \qquad ( 1 )$$

Where T is a predefined total number of steps (typically 1000). The schedule {βₜ}_{t∈[T]} is chosen such that the data distribution q(x₀) is gradually transformed into an approximately Gaussian distribution qT(x_{T})≈ [symbol] (0, I). Diffusion models then learn to approximate the data distribution by reversing such diffusion process, starting from a Gaussian distribution p(x_{T})= [symbol] (x_{T}|0, I).

$${p}_{θ} ( {x}_{0 : T} ) = p ( {x}_{T} ) = {\prod }_{t = 1}^{T} {p}_{θ} ( {x}_{t - 1} \vert {x}_{t} ) , \\ {p}_{θ} ( {x}_{t - 1} \vert {x}_{t} ) = 𝒩 ( {x}_{t - 1} \vert {μ}_{θ} ( {x}_{t} , t ) , {σ}_{t} I ) , \qquad ( 2 )$$

Where μ_{θ}(xₜ, t) is parameterized using a noise prediction network ∈θ(xₜ, t) with

$${μ}_{θ} ( {x}_{t} , t ) = \frac{1}{\sqrt{{α}_{t}}} ( {x}_{t} - \frac{{β}_{t}}{\sqrt{1 - {\overline{α}}_{t}}} {ϵ}_{θ} ( {x}_{t} , t ) ) , {α}_{t} = 1 - {β}_{t} , {\overline{α}}_{t} = {\prod }_{s = 1}^{t} {α}_{s} ,$$

and {σₜ}_{t∈[T]}are pre-determined noise variances. After training, generating from diffusion models involves sampling from the reverse process p_{θ}(x_{0:T}), which begins by sampling a noise variable x_{T}˜p(x_{T}), and then proceeds to obtain x₀ as follows:

$${x}_{t - 1} = \frac{1}{\sqrt{{α}_{t}}} ( {x}_{t} - \frac{{β}_{t}}{\sqrt{1 - {\overline{α}}_{t}}} {ϵ}_{θ} ( {x}_{t} , t ) ) + {σ}_{t} {w}_{t} , {w}_{t} \sim 𝒩 ( 0 , I ) . \qquad ( 3 )$$

Common diffusion models include the latent diffusion models (LDM), whose forward/reverse diffusion processes are defined in the latent space. With image encoder f_{Enc} and decoder f_{Dec}, LDMs are trained on latent representations z₀=f_{Enc}(x₀). To generate an image, LDMs first sample a latent noise z_{T}, run the reverse process to obtain z₀, and decode it with x₀=f_{Dec}(z₀).

For the text-to-image diffusion models, the noise prediction network ∈θ accepts an additional text prompt P, i.e., ∈_{θ}(g_{ϕ}(P), xₜ,t), where g_{ϕ} represents a pretrained text encoder parameterized by ϕ. Most T2I models, including Stable Diffusion, further employ LDM and thus use a text-conditional noise prediction model in the latent space, denoted as εθ(g_{ϕ}(P), zₜ, t), which serves as the central focus of our work. Sampling from T2I diffusion models additionally utilizes the classifier-free guidance technique.

### Method

For the present invention, the method consists of (i) a loss design that steers specific attributes of the generated images towards a target distribution while preserving image semantics, and (ii) adjusted direct finetuning of the diffusion model's sampling process.

### Loss Design

In some embodiments, the loss consists of the distributional alignment loss [symbol] ^{aliga} and the image semantics preserving loss [symbol] ^{img}. The distributional alignment loss (DAL) [symbol] ^{align}: Suppose the system want to control a categorical attribute of the generated images that has K′ classes and align it towards a target distribution [symbol] . Each class is represented as a one-hot vector of length K and [symbol] is a discrete distribution over these classes. The system first generates a batch of images [symbol] ={x⁽ⁱ⁾}i∈|N|] using the diffusion model being finetuned and some prompt P. For every generated image x⁽ⁱ⁾, the system uses a pre-trained classifier h to produce a class probability vector p⁽ⁱ⁾=[p₁⁽ⁱ⁾, . . . , p_{K}⁽ⁱ⁾=h(x⁽ⁱ⁾), with Pₖ⁽ⁱ⁾ denoting the estimated probability that x⁽ⁱ⁾ is from class k. Assume there are another set of vectors {u⁽ⁱ⁾}i∈[N] that represents the target distribution and where every u⁽ⁱ⁾ is a one-hot vector representing a class, the system can compute the optimal transport (OT) from {p⁽ⁱ⁾}_{iE[N]} to {u⁽ⁱ⁾}_{i∈[N]};

$${σ}^{*} = {arg min}_{σ ∈ {𝒮}_{N}} {\sum }_{i = 1}^{N} {\vert {p}^{( i )} - {u}^{( {σ}_{i} )} \vert}_{2} , \qquad ( 4 )$$

where S_{N} denotes all permutations of [N], σ=[σ₁, . . . σ_{N}], and σᵢ∈[N] Intuitively, σ*finds, in the class probability space, the most efficient modification of the current images to match the target distribution. The system constructs {u⁽ⁱ⁾}_{i∈[N]} to be Independent and Identically Distributed Data (IID) samples from the target distribution and compute the expectation of OT:

$${q}^{( i )} = {𝔼}_{{u}^{( 1 )} , … , {u}^{( N )} \sim 𝒟} [ {u}^{( {σ}_{i}^{*} )} ] , ∀ i ∈ [ N ] . \qquad ( 5 )$$

q⁽ⁱ⁾ is a probability vector where the k-th element is the probability that image x⁽ⁱ⁾ should have target class k; had the batch of generated images indeed followed the target distribution [symbol] . The expectation of OT can be computed analytically when the number of classes K′ is small or approximated by empirical average when K increases. It is noted that one can also construct a fixed set of {u⁽ⁱ⁾}_{i∈[N]}, for example half male and half female to represent a balanced gender distribution. But a fixed split poses a stronger finite-sample alignment objective and neglects the sensitivity of OT.

Finally, the system generates target classes {y⁽ⁱ⁾}_{i∈[N]} and confidence of these targets {c⁽ⁱ⁾}_{i∈[N]} by: y⁽ⁱ⁾=arg max(q⁽ⁱ⁾)∈[K], c⁽ⁱ⁾=max(q⁽ⁱ⁾∈[0, 1], ∀i∈[N]. The system defines DAL as the cross-entropy loss with respect to these dynamically generated targets, with a confidence threshold C,

$${ℒ}_{align} = \frac{1}{N} {\sum }_{i = 1}^{N} [ {c}^{( i )} \geq C ] {ℒ}_{CE} ( h ( {x}^{( i )} ) , {y}^{( i )} ) . \qquad ( 6 )$$

The system also uses an image semantics preserving loss [symbol] img. The system keeps a copy of the frozen, not finetuned diffusion model and penalize the image dissimilarity measured by Contrastive Language-Image Pretraining (CLIP) and self-Distillation with No Labels (DINO): CLIP and DINO are two powerful models for image understanding, and both can be used to measure image similarity. CLIP is developed to understand both images and text in a unified way. It is designed to match images and text embeddings in the same latent space. DINO is a self-supervised learning model that learns without needing labeled datasets. DINO is good at finding image similarities based on what it learns without needing any labels or guidance.

$${ℒ}_{img} = \frac{1}{N} {\sum }_{i = 1}^{N} [ \text{} ( 1 - cos ( CLIP ( {x}^{( i )} ) , CLIP ( {o}^{( i )} ) ) ) + ( 1 - cos ( DINO ( {x}^{( i )} ) , DINO ( {o}^{( i )} ) ) ) ] , \\ where {ℐ}^{′} = {\{ {o}^{( i )} \}}_{i ∈ [ N ]} \qquad ( 7 )$$

is the batch of images generated by the frozen model using the same prompt P. They are called original images. The system requires every pair of finetuned image a) and original image o⁽ⁱ⁾ are generated using the same initial noise. The system uses both CLIP and DINO because CLIP is pretrained with text supervision and DINO is pretrained with image self-supervision. In implementation, the system uses the laion/CLIP-ViT-H-14-laion2B-s32B-b79K and the dinov2-vitb 14.

### Adaptation for Face-Centric Attributes

For the current invention, the system focuses on face-centric attributes such as gender, race, and age. It is found that the following adaptation from the general case yields the best results. First, the system uses a face detector d_{face} to retrieve the face region d_{face}(x⁽ⁱ⁾) from every generated image x⁽ⁱ⁾. The system applies the classifier h and the DAL [symbol] _{align} only on the face regions. Second, the system introduces another face realism preserving loss [symbol] _{face}, which penalize the dissimilarity between the generated face d_{face}(x⁽ⁱ⁾) and the closest face from a set of external real faces [symbol] ^{F},

$${ℒ}_{face} = \frac{1}{N} ( 1 - {min}_{F ∈ {𝒟}_{F}} cos ( emb ( {d}_{face} ( {x}^{( i )} ) ) , emb ( F ) ) . \qquad ( 8 )$$

where emb(.) is a face embedding model. [symbol] _{face} helps retain realism of the faces, which can be substantially edited by the DAL. In the implementation, the system uses the CelebA and the FairFace dataset as external faces. The system uses the SFNet-20 (as the face embedding model). The CelebA dataset is a large-scale face dataset commonly used for facial recognition, attribute prediction, and other computer vision tasks. It is widely known for its size, diversity, and the variety of labeled facial attributes. FairFace dataset is a face image dataset which is race balanced. It contains images from 7 different race groups: White, Black, Indian, East Asian, Southeast Asian, Middle Eastern, and Latino.

The final loss [symbol] is a weighted sum; [symbol] = [symbol] _{align}+λ_{img} [symbol] _{img}+λ_{face} [symbol] _{face}. Notably, the system uses a dynamic weight λ_{img}. The system uses a larger λ_{img,1} if the generated image x⁽ⁱ⁾'s target class y⁽ⁱ⁾ agrees with the original image o⁽ⁱ⁾'s class h(d_{face}(o⁽ⁱ⁾)). Intuitively, the system encourages minimal change between x⁽ⁱ⁾ and o⁽ⁱ⁾ if the original image o⁽ⁱ⁾ already satisfies the distributional alignment objective. For other images x⁽ⁱ⁾ whose target class y⁽ⁱ⁾ does not agree with the corresponding original image o⁽ⁱ⁾'s class h(d_{face}(o⁽ⁱ⁾)), the system uses a smaller weight λ_{img,2} for the non-face region and the smallest weight λ_{img,3} for the face region. Intuitively, these images do require editing, particularly on the face regions. Finally, if an image does not contain any face, the system only applies [symbol] ᵢₘₑ but not [symbol] _{align} and [symbol] _{face}. If an image contains multiple faces, the system focuses on the one occupying the largest area.

### Adjusted Direct Finetuning of Diffusion Model's Sampling Process

Consider that the T2I diffusion model generates an image x₀=f_{Dec}(z₀) using a prompt P and an initial noise z_{T}. The goal is to finetune the diffusion model to minimize a differentiable loss [symbol] (x₀).

In some embodiments, the system computes the exact gradient of [symbol] (x₀) in the sampling process, followed by gradient-based optimization.

By explicitly writing down the gradient, the system analyzes the gradient with respect to the U-Net parameter, dθ/d [symbol] (x0) U-Net is a convolutional neural network and skip-connect based codec network that is typically used to generate images of the same size as the input image.

$$\frac{d ℒ ( {x}_{0} )}{d θ} = \frac{d ℒ ( {x}_{0} )}{{dx}_{0}} \frac{{dx}_{0}}{{dz}_{0}} \frac{{dz}_{0}}{d θ} , \\ with \frac{{dz}_{0}}{d θ} = - \underbrace{\frac{1}{\sqrt{{\overline{α}}_{1}}} \frac{{β}_{1}}{\sqrt{1 - {\overline{α}}_{1}}}}_{{A}_{1}} \underbrace{I}_{{B}_{1}} \frac{\partial {ϵ}^{( 1 )}}{\partial θ} - {\sum }_{t = 2}^{T} ( \underbrace{\frac{1}{\sqrt{{\overline{α}}_{1}}} \frac{{β}_{1}}{\sqrt{1 - {\overline{α}}_{1}}}}_{{A}_{t}} \underbrace{( {\prod }_{s = 1}^{t - 1} ( 1 - \frac{{β}_{s}}{\sqrt{1 - {\overline{α}}_{s}}} \frac{\partial {ϵ}^{( s )}}{\partial {z}_{s}} ) )}_{{B}_{t}} \frac{\partial {ϵ}^{( t )}}{\partial θ} ) , \qquad ( 9 )$$

where ∈^{(t)} denotes the U-Net function ∈_{θ}(gϕ(P), zₜ, t) evaluated at time step t. Importantly, the recurrent evaluations of U-Net in the reverse diffusion process leads to a factor Bₜ that scales exponentially in t.

In some embodiments, the system applies adjusted DFT, which uses an adjusted gradient that sets

$${A}_{t} = 1 and {B}_{t} = {{I}_{:} ( \frac{{dz}_{0}}{d θ} )}_{adjusted} = - {\sum }_{t = 1}^{T} \frac{\partial {ϵ}^{( t )}}{θ} .$$

It is motivated from the unrolled expression of the reverse process:

$${z}_{0} = - {\sum }_{t = 1}^{T} {A}_{t} ϵ ( {g}_{ϕ} ( P ) , {z}_{t} , t ) + \frac{1}{\sqrt{{\overline{α}}_{1}}} {z}_{t} + {\sum }_{t = 2}^{T} \frac{1}{\sqrt{{\overline{α}}_{t - 1}}} {w}_{t} , \\ {w}_{t} \sim 𝒩 ( 0 , I ) . \qquad ( 10 )$$

When the system sets Bₜ=I, the system is essentially considering zₜ as an external variable and independent of the U-Net parameters θ, rather than recursively dependent on θ. Otherwise, by the chain rule, it generates all the coupling between partial gradients of different time steps in Bₜ. But setting Bₜ=I does preserve all uncoupled gradients, i.e., ∂θ/∂∈(t), ∀t∈[T]. When the system sets Aₜ=1, it standardizes the influence of ∈(g_{ϕ}(P), zₜ, t) from different time steps t in z₀. It is known that weighting different time steps properly can accelerate diffusion training. Finally, the system implements adjusted DFT in the following Algorithm A.1.

Algorithm A.1: Adjusted DFT of diffusion model

| | |
|---|---|
| input: text encoder g_{ϕ}; U-Net ϵ_{θ}; image decoder f_{Dec}; loss function [symbol] ; variance schedule | |
| {βₜ ∈ (0, 1)]}_{t∈[T]} and coresponding {αₜ}_{t∈[T]}, {α̅ₜ}_{t∈[T]}; prompt P; diffusion | |
| scheduler scheduler; inference time step schedule t₁ = T, t₂, ... , t_{S} = 0. | |
| /* Prepare grade coefficients. | */ |

for i = 1, 2, ... , S − 1 do

| | |
|---|---|
| \| ${C}_{i} ← 1 / ( \text{?} ) ;$ | |
| end | |
| C ← [C₁, ... , C_{S-1}]/(Πₜ₌₁^{K-1} Cₜ)^{1/(S-1)}; | */ |
| /* T2I w/adjusted gradient | |
| zₜ ← z_{T} ~ N(0, 1); | |
| for i = 1, 2, ... , S − 1 do | |
| \| t, tₚᵣₑᵥ ← tᵢ, tᵢ₊₁; | |
| \| zₜ′ ← detach(zₜ); | |
| \| ϵₜ ←f_{θ}(g_{ϕ}(P), zₜ′, tₜ); | |
| \| ϵₜ′ ← ϵₜ grad_hook (g:g × C[i]); | |
| \| zₜ_{ₚᵣₑᵥ} ← schedular(zₜ, ϵₜ′, t, tₚᵣₑᵥ); | |
| end | |

x₀ ← f_{Dec}(z₀);
$Backpropagate gradient \frac{d \text{?} ( {x}_{0} )}{d {x}_{0}} from generated image {x}_{0} to U - Net θ , text encoder ϕ , or$
prompt P
$\text{?} \text{indicates text missing or illegible when filed}$

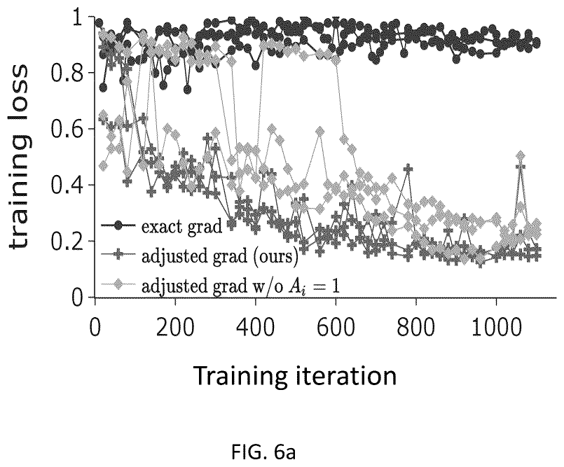

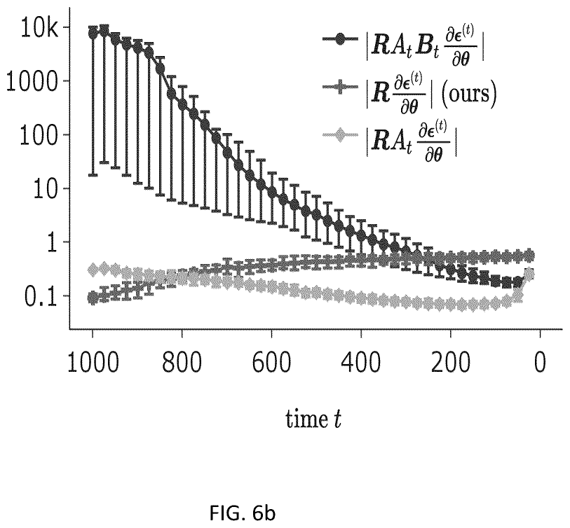

FIG. 6a is a chart of the training loss during direct finetuning with three distinct gradients according to an embodiment of the invention. It shows the unadjusted gradient, adjusted gradient and a variant that does not standardize Aᵢ for the same image semantics preserving loss with the same fixed target image. The training loss shows no significant decrease after 1000 iterations, indicating that the unadjusted gradient applied to diffusion models is ineffective in optimizing the training process. However, when an adjusted gradient is introduced, the training loss is substantially reduced, demonstrating improved optimization and more effective learning. This highlights the importance of gradient adjustments for enhancing model performance during the training of diffusion models. Moreover, standardizing Aᵢ further stabilizes the optimization process.

FIG. 6b is a chart of the scales of the gradients at different time steps according to an embodiment of the invention. Mean and 90% CI are computed from 20 random runs.

For the gradient value in eq. 9, dθ/dz0 becomes dominated by the components AtBt ∂θ/∂∈(t) for values of t close to T=1000. Further, due to the fact that Bₜ encompasses all possible products between

$$\{ \frac{\partial \text{?}}{\partial {z}_{s}} \} s \leq t - 1 ,$$

$$\text{?} \text{indicates text missing or illegible when filed}$$

this coupling between partial gradients of different time steps introduces substantial variance to dθ/dz₀. The system assumes dx0/d [symbol] (x0), dz0/dx0 is a random Gaussian matrix R˜ [symbol] (0, 10⁻⁴×I) and plots the values of |R,AₜBₜ∂θ/∂∈(t)|, |RAₜ∂θ/∂∈(t)|, and |R∂θ/∂∈(t)| in FIG. 6b. It is apparent both the scale and variance of |RAₜBₜ∂θ/∂∈(t)| explodes as t→1000, but neither |RAt ∂θ/∂∈(t)| nor |R∂θ/∂∈(t)| do.

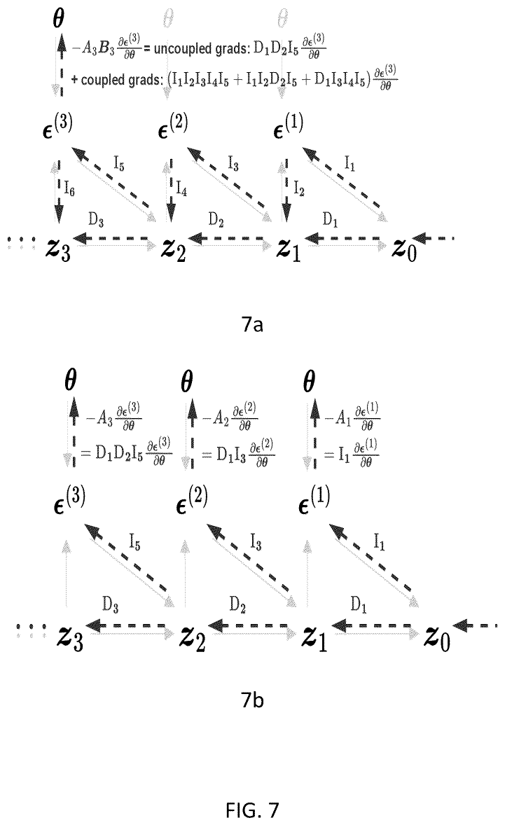

FIG. 7 shows the comparison of unadjusted and adjusted direct finetuning of the diffusion model of the sampling process according to an embodiment of the invention. Gray solid lines denote the sampling process. Dashed lines highlight the gradient computation with respect to the model parameter (θ). Variables zₜ and ∈^{(t)} represent data and noise prediction at time step t. Dᵢ and Iᵢ denote the direct and indirect gradient paths between adjacent time steps. For instance, at t=3, the unadjusted DFT computes the exact gradient

$$- {A}_{3} {B}_{3} \frac{\partial {ϵ}^{( 3 )}}{\partial θ}$$

(defined in Eq. 9), which involves other time step's noise predictions (through the gradient paths I₁I₂I₃I₄I₅, I₁I₂D₂I₅, and D₁I₃I₄I₅). Adjusted DFT leverages an adjusted gradient, which removes the coupling with other time steps and standardizes Aᵢ to 1, for more effective finetuning.

### Experiments

Mitigating Gender, Racial, and their Intersectional Biases

To reduce the memory footprint, in all experiments the system can (i) quantize the diffusion model to float16, (ii) apply gradient checkpointing and (iii) use DPM-Solver++ as the diffusion scheduler, which only requires around 20 steps for T2I generations.

In some embodiments, the method is applied to runwayml/stable-diffusion-v1-5 (SD for short), a T2I diffusion model openly accessible from Hugging Face, to reduce gender, racial, and their intersectional biases. The system adopts the four race categories from the FairFace dataset: WMELH={White, Middle Eastern, Latino Hispanic}, Asian={East Asian, Southeast Asian}, Black, and Indian. The gender and race classifiers used in DAL are trained on the CelebA or FairFace datasets. The system considers a uniform distribution over gender, race, or their intersection as the target distribution. The system employs the prompt template “a photo of the face of a {occupation}, a person” and use 1000/50 occupations for training/test. For the main experiments and except otherwise stated, the system finetune LoRA with rank 50 applied on the text encoder.

In some embodiments for the gender debiasing experiment, the system trains a gender classifier using the CelebA dataset. The system uses CelebA faces as external faces for the face realism preserving loss. The system sets λ_{face}=1, λ_{img,1}=8, λ_{img,2}=0.2×λ_{img,1}, and λ_{img,3}=0.2×λ_{img,2}. The system uses batch size N=24 and set the confidence threshold for the distributional alignment loss C=0.8. The system trains for 10k iterations using AdamW optimizer with learning rate 5e-5. The system checkpoints every 200 iterations and reports the best checkpoint. The finetuning takes around 48 hours on 8 NVIDIA A 100 GPUs.

In some embodiments for the race debiasing experiment, the system trains a race classifier using the FairFace dataset. The system uses FairFace faces as external faces for the face realism preserving loss. The system sets λ_{face}=0.1, λ_{img,1}=6, λ_{img,2}=0.6 ×λ_{img,1}, and λ_{img,3}=0.3×λ_{img,2}. The system uses batch size N=32 and set the confidence threshold for the distributional alignment loss C=0.8. The system train for 12k iterations using AdamW optimizer with learning rate 5e-5. The system checkpoints every 200 iterations and reports the best checkpoint. The finetuning takes around 48 hours on & NVIDIA A 100 GPUs.

In some embodiments for the experiment that debiases gender and race jointly, the system trains a classifier that classifies both gender and race using the FairFace dataset. The system uses FairFace faces as external faces for the face realism preserving loss. The system sets λ_{face}=0.1 and W_{img,1}=8. For the gender attribute, the system uses λ_{img,2}=0.2×λ_{img,1}, and λ_{img,3}=0.2×λ_{img,2}. For the race attribute, the system uses λ_{img,2}=0.6×λ_{img,1} and λ_{img,3}=0.3×λ_{img,2}. The system uses batch size N=32 and set the confidence threshold for the distributional alignment loss C=0.6. The system train for 14k iterations using AdamW optimizer with learning rate 5e-5. The system checkpoints every 200 iterations and reports the best checkpoint. The finetuning takes around 48 hours on 8 NVIDIA A100 GPUS.

The system trains separate gender and race classifiers for evaluation. The system generates 60, 80, or 160 images for each prompt to evaluate gender, racial, or intersectional biases, respectively. For every prompt P, the system computes the following metric:

$$bias ( P ) = \frac{1}{K ( K - 1 ) / 2} {\sum }_{i , j ∈ [ K ] : i < j} \vert freq ( i ) - freq ( j ) \vert ,$$

where freq(i) is group i's frequency in the generated images. The number of groups K is 2/4/8 for gender/race/their intersection. The classification of an image into a specific group is based on the face that covers the largest area. This bias metric considers a perfectly balanced target distribution. It measures the disparity of different groups' representations, averaged across all contrasting groups.

The method consistently achieves the lowest bias across all three scenarios. Furthermore, the method still maintains a strong alignment with the text prompt.

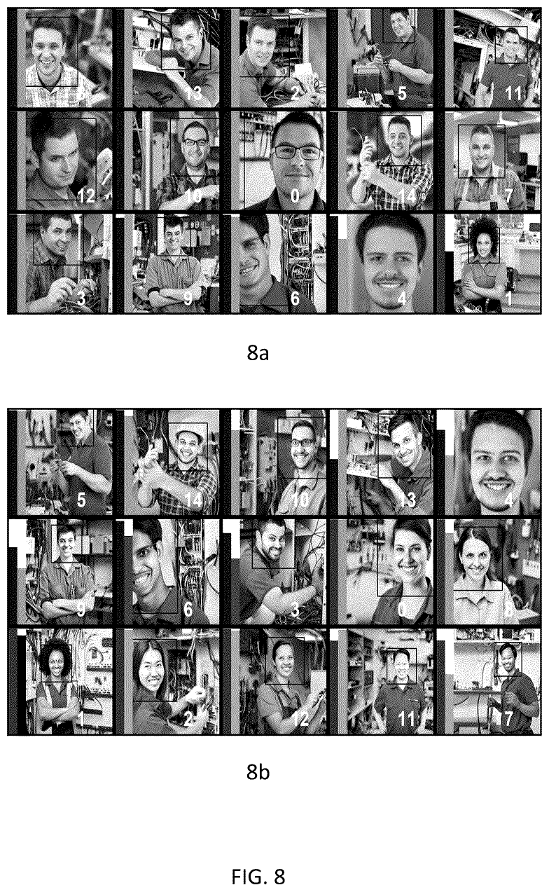

FIG. 8 shows the images generated from the original stable diffusion model (8a) and the jointly debiased stable diffusion model (8b) for gender and race, according to an embodiment of the invention. It demonstrates the effectiveness of the debiasing process. The models are evaluated using an unseen occupation prompt: “a photo of the face of an electrical and electronics repairer, a person.”

In the original Stable Diffusion (SD) model, significant biases are present, with a gender bias score of 0.84, a racial bias score of 0.48, and a combined gender-race bias score of 0.24. This version predominantly generates images of white males, marginalizing other identities such as female, Black, Indian, Asian individuals, and intersections of these categories.

In contrast, the jointly debiased model significantly reduces these biases, achieving a gender bias score of 0.11, a racial bias score of 0.10, and a combined gender-race bias score of 0.06. The debiased model greatly improves the representation of minority groups, providing a more balanced and inclusive depiction of individuals across gender and race, especially for the occupation “electrical and electronics repairer” from the test set.

### Ablation on Different Components to Finetune.

The system finetunes various components of stable diffusion to reduce gender bias, with results reported in Table 1. First, the method proves highly robust to the number of parameters finetuned. By optimizing merely five soft tokens as prompt prefix, gender bias can already be significantly mitigated. Second, Table 1 suggests finetuning both the text encoder and U-Net is the most effective.

The findings shed light on the decisions regarding which components to finetune when debiasing diffusion models. In some embodiments, it prioritizes the finetuning the language understanding components, including the prompt and the text encoder. By doing so, it encourages the model to maintain a holistic visual representation of gender and racial identities, rather than manipulating low-level pixels to signal gender and race.

TABLE 1
Finetuning different SD components. For prompt prefix, five soft
tokens are finetuned. For others, LoRA w/ rank 50 is finetuned.

| Finetued | Bias ↓ | Semantics Preservation ↑ | | |
|---|---|---|---|---|
| Component | Gender | CLIP-T | CLIP-I | DINO |
| Original SD | .67 ± .29 | .39 ± .05 | — | — |
| Prompt Prefix | .24 ± .19 | .39 ± .05 | .70 ± .15 | .62 ± .22 |
| Text Encoder | .23 ± .16 | .39 ± .05 | .77 ± .15 | .70 ± .22 |
| U-Net | .22 ± .14 | .39 ± .05 | .90 ± .09 | .87 ± .13 |
| T.E. & U-Net | .17 ± .13 | .40 ± .04 | .80 ± .14 | .74 ± .20 |

### Distributional Alignment of Age

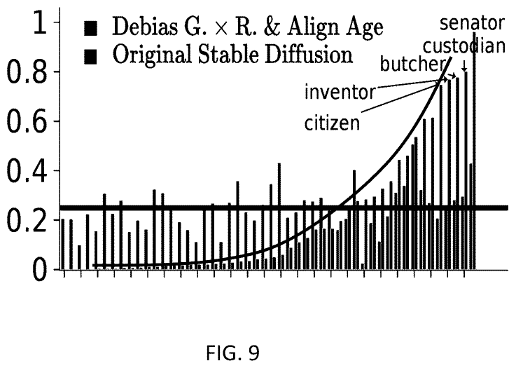

FIG. 9 is a chart of the frequency of age=old representations in generated images across various occupations for both the debiased diffusion model and the original stable diffusion according to an embodiment of the invention. The x-axis denotes different occupations, while the horizontal line at 25% represents the target distribution of “old” representations. For each occupation, it shows the results of the original Stable Diffusion model alongside the debiased G.XR. & Align Age results. The debiased G.XR. & Align Age results are shown on the left, while the original Stable Diffusion model results are on the right. The horizontal line near the 25% value represents the distribution of the debiased diffusion model, while the curved line shows the distribution of the original stable diffusion model.

The system can align the age distribution to a non-uniform distribution, specifically 75% young and 25% old, for every occupational prompt while simultaneously debiasing gender and race. Utilizing the age attribute from the FairFace dataset, young is defined as ages 0-39 and old encompasses ages 39 and above. To avoid the pitfall that the model consistently generating images of young white females and old black males, we finetune with a stronger DAL that aligns age toward the target distribution conditional on gender and race. The system evaluates using an independently trained age classifier.

As shown in FIG. 9, in the case of the debiased diffusion model, the frequency of “old” representations is consistently close to the 25% target line across most occupations, indicating the model's success in mitigating age-related biases. Conversely, the original stable diffusion model follows the trend of the curved line, deviating from the target and displaying a less balanced distribution of “old” representations.

### Debiasing Multiple Concepts at Once

The system can debias multiple concepts at once by simply including these prompts in the finetuning data and hence the method is scalable. In some embodiments, the system debiases SD using a mixture of the following four classes of prompts: (1) occupational prompts: formulated with the template “a photo of the face of a {occupation}, a person”. The system utilizes the same 1000/50 occupations for training/testing. (2) sports prompts: formulated with the template “a person playing {sport}”. The system uses 250/50 sports activities for training/testing, such as “yoga”, “kickboxing”, and “ninjutsu”. (3) Occupational prompts with style & context: these are non-templated prompts that specify occupations with diverse styles or contexts. The system train/test on 150/19 such prompts obtained from the captions in the LAION-AESTHETICS dataset. For instance, one example reads, “an aesthetic portrait of a magician working on ancient machines to do magic, concept art”. And finally, (4) personal descriptors: these prompts describe individual(s). The system uses 40/10 such prompts for training/testing. Examples include “hot personal trainer” and “Oil painting of a person wearing colorful fabric”.

Table 2 reports the evaluation. The debiased SD reduces gender, racial, and intersectional biases for all four concepts without degrading prompt-image alignment. it increases the probability of generating images that blend male and female characteristics compared with single concept debiasing.

TABLE 2
Debiasing gender, racial, and intersectional biases for multiple concepts at once.

| | Occupations | | | | Sports | | | | Occ. w/ style & context | | | | Personal descriptors | | | |
|---|---|---|---|---|---|---|---|---|---|---|---|---|---|---|---|---|
| | Bias ↓ | | | S.P. ↑ | Bias ↓ | | | S.P. ↑ | Bias ↓ | | | S.P. ↑ | Bias ↓ | | | S.P. ↑ |
| | G. | R. | G. × R. | CLIP-T | G. | R. | G. × R. | CLIP-T | G. | R. | G. × R. | CLIP-T | G. | R. | G. × R. | CLIP-T |
| SD | .67 ± | .42 ± | .21 ± | .38 ± | .56 ± | .38 ± | .19 ± | .35 ± | .41 ± | .37 ± | .18 ± | .43 ± | .37 ± | .36 ± | .17 ± | .41 ± |
| | .29 | .06 | .03 | .05 | .28 | .05 | .03 | .06 | .26 | .08 | .03 | .05 | .26 | .06 | .03 | .04 |
| Ours | .23 ± | .10 ± | .07 ± | .38 ± | .37 ± | .11 ± | .08 ± | .35 ± | .31 ± | .19 ± | .11 ± | .42 ± | .18 ± | .13 ± | .07 ± | .41 ± |
| | .18 | .04 | .02 | .05 | .23 | .06 | .04 | .05 | .20 | .07 | .03 | .05 | .17 | .06 | .03 | .04 |

In summary, for the current system, it consists of two main technical contributions. First, it designs a loss function that steers the generated images towards the desired distribution while preserving image semantics. A key component is the distributional alignment loss (DAL). For a batch of generated images, DAL uses pre-trained classifiers to estimate class probabilities (e.g., male and female probabilities) and dynamically generates target classes that match the target distribution and have the minimum transport distance. To preserve image semantics, the system regularizes CLIP and DINO similarities between images generated by the original and finetuned models.

Second, the system applies adjusted direct finetuning of diffusion models. The adjusted DFT aims to directly finetune the diffusion model's sampling process to minimize any loss defined on the generated images. It opens venues for more refined and targeted diffusion model finetuning and can be applied for objectives beyond fairness.

Empirically, the system markedly reduces gender, racial, and their intersectional biases for occupational prompts. The debiasing is effective even for prompts with unseen styles and contexts. The method is adaptable to any component of the diffusion model being finetuned. Ablation study shows that finetuning the text encoder while keeping the U-Net unchanged hits a sweet spot that effectively mitigates biases and lessens potential negative effects on image quality. Surprisingly, finetuning as few as five soft tokens as a prompt prefix is able to largely reduces gender bias, demonstrating the effectiveness of soft prompt tuning for fairness. These results underscore the robustness of the method and the efficacy of debiasing T2I diffusion models by finetuning their language understanding components.

Aspects of the disclosed invention can include one or more of the following:

Aspect 1. A method of generating images from a text to reduce bias using a diffusion model, comprising: receiving a text input; and generating images corresponding to the text input using the diffusion model, wherein the diffusion model is optimized by: aligning the generated images toward a target distribution using a distributional alignment loss; and adjusting the diffusion model by direct finetuning a sampling process by adjusting a gradient to minimize a loss function of the generated images.

Aspect 2. The method of Aspect 1, wherein the step of aligning the generated images further comprising: identifying attributes in the generated images using pre-trained classifiers; and aligning the identified attributes of the generated images toward a target attribute distribution using the distributional alignment loss.

Aspect 3. The method of any of claims 1-2, wherein the step of aligning the generated images further comprising: applying pre-trained classifiers to estimate class probabilities of the generated images, including probabilities for specific classes; calculating a transport distance between the estimated class probabilities of the generated images and the target distribution; and dynamically generating the class distributions of the generated images that match the target distribution by minimizing the transport distance.

Aspect 4. The method of any of Aspects 1 to 3, wherein the distributional alignment loss is applied iteratively until generated image features align with the target distribution.

Aspect 5. The method of any of Aspects 1 to 4, wherein the distributional alignment loss further comprises: an alignment loss that measures a discrepancy between the generated image and a target distribution, an image semantics preserving loss that measures a semantic consistency of the generated image with the input text, a face realism preserving loss that penalizes the dissimilarity between the generated face and a closest face from a set of external real faces, or a combination thereof.

Aspect 6. The method of any of Aspects 1 to 5, wherein the distributional alignment loss is a weighted sum of the alignment loss, the image semantics preserving loss, and/or the face realism preserving loss

Aspect 7. The method of any of Aspects 1 to 6, wherein the target distribution is a user defined target distribution and includes one or more attributes.

Aspect 8. The method of any of Aspects 1 to 7, wherein the target distribution is a non-uniform distribution over gender, race or their intersection.

Aspect 9. The method of Aspects 1 to 8, wherein the non-uniform distribution is over age, gender, race or their intersection.

Aspect 10. The method of any of Aspects 1 to 9, wherein the step of direct finetuning a sampling process further comprises: preparing gradient coefficients of the diffusion model; calculating a gradient value from the gradient coefficients; adjusting the gradient value to optimize the diffusion model by minimizing the loss function; and backpropagating the adjusted gradient value through the diffusion model to update model parameters.

Aspect 11. The method of any of Aspects 1 to 10, wherein the gradient value is calculated based on partial derivatives of the loss function with respect to the model parameters.

Aspect 12. The method of any of Aspects 1 to 11, further comprising: debiasing multiple concepts at once by including different inputs in a finetuning data.

Aspect 13. The method of any of Aspects 1 to 12, wherein the text input is processed using a natural language processing model to understanding semantic features before being used by the diffusion model for the image generation.

Aspect 14. The method of any of Aspects 1 to 13, wherein the finetuning process adjusts the diffusion model's parameters using five soft tokens.

Aspect 15. The method of any of Aspects 1 to 14, wherein the diffusion model is a text to image model.

Aspect 16. A system for generating images from a text to reduce bias using a diffusion model, comprising: a processor; a memory in electronic communication with the processor; and instructions stored in the memory and executable by the processor to cause the system to perform operations for: receiving a text input; and generating images corresponding to the text input using the diffusion model, wherein the diffusion model is optimized by aligning the generated images toward a target distribution using a distributional alignment loss; and adjusting the diffusion model by direct finetuning a sampling process by adjusting a gradient to minimize a loss function of the generated images.

Aspect 17. The system of Aspect 16, wherein the processor is further configured to perform operations for: applying pre-trained classifiers to estimate class probabilities of the generated images, including probabilities for specific classes; calculating a transport distance between the estimated class probabilities of the generated images and the target distribution; and dynamically generating the class distributions of the generated images that match the target distribution by minimizing the transport distance.

Aspect 18. The system of any of Aspects 16 to 17, wherein the distributional alignment loss further comprises an alignment loss that measures a discrepancy between the generated image and a target distribution, an image semantics preserving loss that measures a semantic consistency of the generated image with the input text, a face realism preserving loss that penalizes the dissimilarity between the generated face and a closest face from a set of external real faces, or a combination thereof.

Aspect 19. An apparatus for generating images from a text to reduce bias using a diffusion model, comprising: means for receiving a text input; means for generating images corresponding to the text input using the diffusion model; and means for computing a gradient matrix for each image in the set of training images; wherein the diffusion model is optimized by aligning the generated images toward a target distribution using a distributional alignment loss; and adjusting the diffusion model by direct finetuning a sampling process by adjusting a gradient to minimize a loss on the generated images.

Aspect 20. A computer-readable storage medium, on which a computer program is stored, wherein the computer program, when executed in a computer, causes the computer to perform operations for: receiving a text input; and generating images corresponding to the text input using the diffusion model, wherein the diffusion model is optimized by: aligning the generated images toward a target distribution using a distributional alignment loss; and adjusting the diffusion model by direct finetuning a sampling process by adjusting a gradient to minimize a loss function of the generated images.

A salient feature of the system is its flexibility, allowing users to specify the desired target distribution. It can effectively adjust the age distribution to achieve a 75% young and 25% old ratio while simultaneously debiasing gender and race. It can debias multiple concepts at once, such as occupations, sports, and personal descriptors, by expanding the set of prompts used for finetuning.

For the current invention, any suitable programming language can be used to implement the routines of particular embodiments including C, C++, Java, assembly language, etc. Different programming techniques can be employed such as procedural or object oriented. The routines can execute on a single processing device or multiple processors.

Particular embodiments may be implemented in a computer-readable storage medium (also referred to as a machine-readable storage medium) for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

While various aspects and embodiments have been disclosed herein, it will be apparent that various other modifications and adaptations of the invention will be apparent to the person skilled in the art after reading the foregoing disclosure without departing from the spirit and scope of the invention and it is intended that all such modifications and adaptations come within the scope of the appended claims. The various aspects and embodiments disclosed herein are for purposes of illustration and are not intended to be limiting, with the true scope and spirit of the invention being indicated by the appended claims.

1. A method of generating images from a text to reduce bias using a diffusion model, comprising:
receiving a text input; and
generating images corresponding to the text input using the diffusion model, wherein the diffusion model is optimized by:
aligning the generated images toward a target distribution using a distributional alignment loss; and
adjusting the diffusion model by direct finetuning a sampling process by adjusting a gradient to minimize a loss function of the generated images.

2. The method of claim 1, wherein aligning the generated images further comprises:
identifying attributes in the generated images using pre-trained classifiers; and
aligning the identified attributes of the generated images toward a target attribute distribution using the distributional alignment loss.

3. The method of claim 1, wherein aligning the generated images further comprises:
applying pre-trained classifiers to estimate class probabilities of the generated images, including probabilities for specific classes;
calculating a transport distance between the estimated class probabilities of the generated images and the target distribution; and
dynamically generating the class distributions of the generated images that match the target distribution by minimizing the transport distance.

4. The method of claim 1, wherein the distributional alignment loss is applied iteratively until generated image features align with the target distribution.

5. The method of claim 1, wherein the distributional alignment loss further comprises:
an alignment loss that measures a discrepancy between the generated image and a target distribution, an image semantics preserving loss that measures a semantic consistency of the generated image with the input text, a face realism preserving loss that penalizes dissimilarity between the generated face and a closest face from a set of external real faces, or a combination thereof.

6. The method of claim 5, wherein the distributional alignment loss is a weighted sum of the alignment loss, the image semantics preserving loss, and/or the face realism preserving loss.

7. The method of claim 1, wherein the target distribution is a user defined target distribution and includes one or more attributes.

8. The method of claim 1, wherein the target distribution is a non-uniform distribution over gender, race or their intersection.

9. The method of claim 8, wherein the non-uniform distribution is over age, gender, race or their intersection.

10. The method of claim 1, wherein finetuning a sampling process further comprises:
preparing gradient coefficients of the diffusion model;
calculating a gradient value from the gradient coefficients;
adjusting the gradient value to optimize the diffusion model by minimizing the loss function; and
backpropagating the adjusted gradient value through the diffusion model to update model parameters.

11. The method of claim 10, wherein the gradient value is calculated based on partial derivatives of the loss function with respect to the model parameters.

12. The method of claim 1, further comprising:
debiasing multiple concepts at once by including different inputs in a finetuning data.

13. The method of claim 1, wherein the text input is processed using a natural language processing model to understand semantic features before being used by the diffusion model for the image generation.

14. The method of claim 1, wherein the finetuning process adjusts the diffusion model's parameters using five soft tokens.

15. The method of claim 1, wherein the diffusion model is a text to image model.

16. A system for generating images from a text to reduce bias using a diffusion model, comprising:
a processor;
a memory in electronic communication with the processor; and
instructions stored in the memory and executable by the processor to cause the system to perform operations for:
receiving a text input; and
generating images corresponding to the text input using the diffusion model, wherein the diffusion model is optimized by aligning the generated images toward a target distribution using a distributional alignment loss; and
adjusting the diffusion model by direct finetuning a sampling process by adjusting a gradient to minimize a loss function of the generated images.

17. The system of claim 16, wherein the processor is further configured to perform operations for:
applying pre-trained classifiers to estimate class probabilities of the generated images, including probabilities for specific classes;
calculating a transport distance between the estimated class probabilities of the generated images and the target distribution; and
dynamically generating the class distributions of the generated images that match the target distribution by minimizing the transport distance.

18. The system of claim 16, wherein the distributional alignment loss further comprises an alignment loss that measures a discrepancy between the generated image and a target distribution, an image semantics preserving loss that measures a semantic consistency of the generated image with the input text, a face realism preserving loss that penalizes the dissimilarity between the generated face and a closest face from a set of external real faces, or a combination thereof.

19. A computer-readable storage medium, on which a computer program is stored, wherein the computer program, when executed in a computer, causes the computer to perform operations for:
receiving a text input; and
generating images corresponding to the text input using the diffusion model, wherein the diffusion model is optimized by:
aligning the generated images toward a target distribution using a distributional alignment loss; and
adjusting the diffusion model by direct finetuning a sampling process by adjusting a gradient to minimize a loss function of the generated images.

20. The computer-readable storage medium of claim 19, on which a computer program is stored, wherein the computer program, when executed in a computer, causes the computer to perform operations for:
identifying attributes in the generated images using pre-trained classifiers; and
aligning the identified attributes of the generated images toward a target attribute distribution using the distributional alignment loss.
